(19) United States
(12) Patent Application Publication
(10) Pub. No.: US 2025/0392411 A1
(43) Pub. Date: Dec. 25, 2025

(54) FEEDBACK BASED AT LEAST IN PART ON ENERGY HARVESTING INFORMATION

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Zhikun WU, Beijing (CN); Linhai HE, San Diego, CA (US); Huilin XU, Temecula, CA (US); Tingfang JI, San Diego, CA (US); Peter GAAL, San Diego, CA (US); Krishna Kiran MUKKAVILLI, San Diego, CA (US); Wanshi CHEN, San Diego, CA (US)

(21) Appl. No.: 18/880,371

(22) PCT Filed: Sep. 1, 2022
(86) PCT No.: PCT/CN2022/116452

§ 371 Date: Dec. 31, 2024

(51) Int. Cl. H04L 1/1812; H04W 8/22; H04W 76/20; H04W 92/18

(52) U.S. Cl. CPC H04L 1/1812; H04W 8/22; H04W 76/20; H04W 92/18

(57) ABSTRACT

Various aspects of the present disclosure generally relate to wireless communication. In some aspects, a wireless communication device (WCD) may transmit an indication of energy harvesting (EH) information of the WCD. The WCD may transmit feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information. Numerous other aspects are described.

### FIELD OF THE DISCLOSURE

Aspects of the present disclosure generally relate to wireless communication and to techniques and apparatuses for feedback based at least in part on energy harvesting information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device (WCD). The method may include transmitting an indication of energy harvesting (EH) information of the WCD. The method may include transmitting feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.

Some aspects described herein relate to a WCD for wireless communication. The wireless communication device may include a memory and one or more processors coupled to the memory. The one or more processors may be configured to transmit an indication of EH information of the WCD. The one or more processors may be configured to transmit feedback on periodic resources, including one or more of a HARQ-ACK or an indication associated with a configuration, selected from a plurality of candidate configurations, the configuration selected based at least in part on the energy harvesting information.

Some aspects described herein relate to a non-transitory computer-readable medium that stores a set of instructions for wireless communication by a WCD. The set of instructions, when executed by one or more processors of the WCD, may cause the WCD to transmit an indication of EH information of the WCD. The set of instructions, when executed by one or more processors of the WCD, may cause the WCD to transmit feedback on periodic resources, including one or more of a HARQ-ACK or an indication associated with a configuration, selected from a plurality of candidate configurations, the configuration selected based at least in part on the energy harvesting information.

Some aspects described herein relate to an apparatus for wireless communication. The apparatus may include means for transmitting an indication of EH information of the apparatus. The apparatus may include means for transmitting feedback on periodic resources, including one or more of a HARQ-ACK or an indication associated with a configuration, selected from a plurality of candidate configurations, the configuration selected based at least in part on the energy harvesting information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of energy harvesting, in accordance with the present disclosure.

FIG. 7 is a diagram illustrating an example of physical sidelink feedback channel (PSFCH) resource allocations, in accordance with the present disclosure.

FIG. 8 is a diagram of an example associated with feedback based at least in part on energy harvesting information, in accordance with the present disclosure.

FIG. 9 is a diagram illustrating an example process performed, for example, by a wireless communication device (WCD), in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

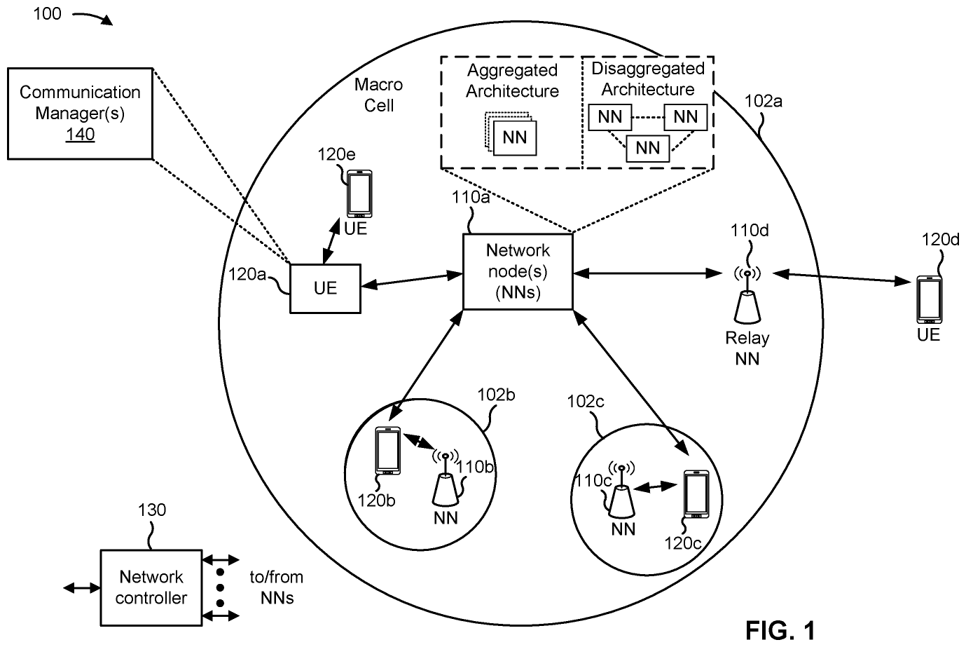

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the wireless communication device (WCD) may include a communication manager 140 or 150. As described in more detail elsewhere herein, the communication manager 140 or 150 may transmit an indication of energy harvesting (EH) information of the WCD; and transmit feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information. Additionally, or alternatively, the communication manager 140 or 150 may perform one or more other operations described herein.

As indicated above, FIG. 1 is provided as an example. Other examples may differ from what is described with regard to FIG. 1.

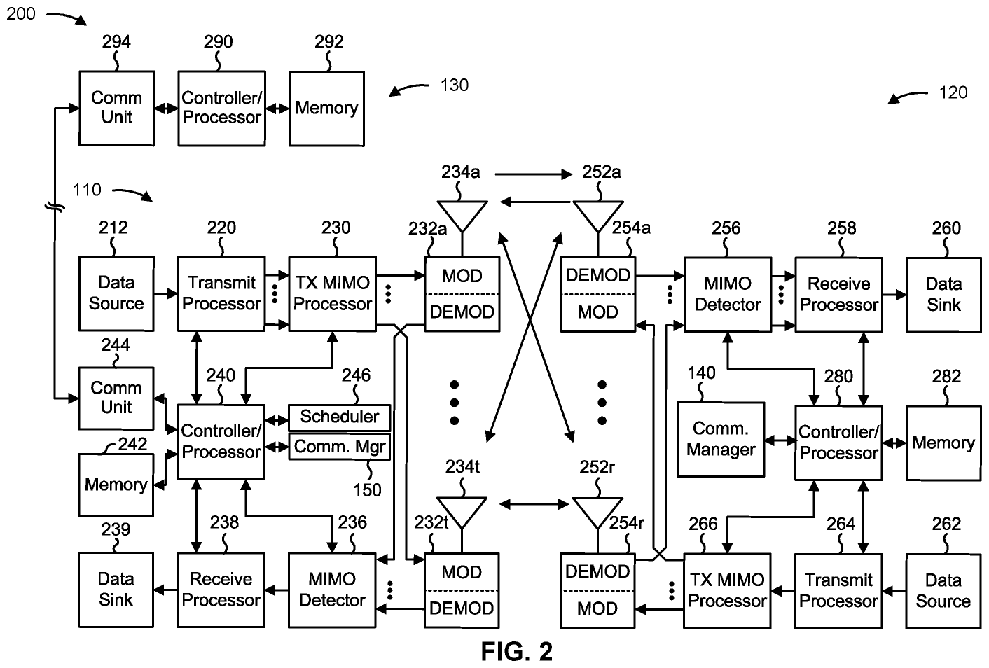

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

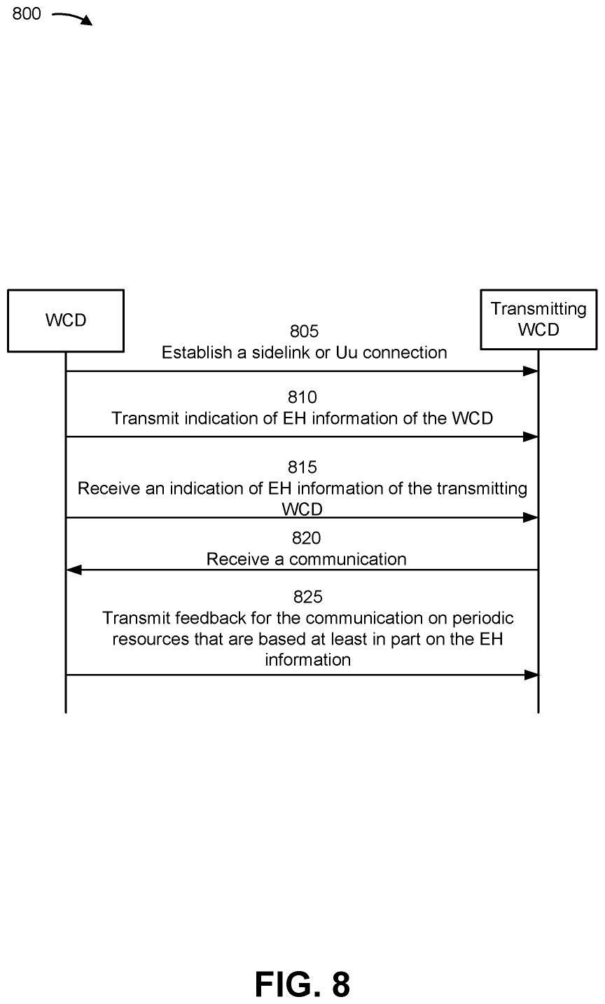

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-10).

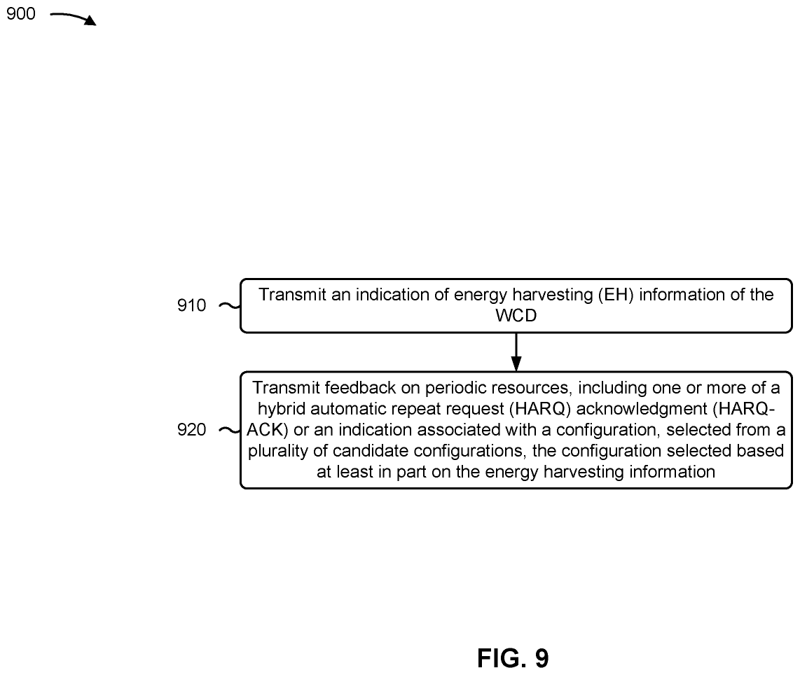

The controller/processor 240 of the network node 110, the controller/processor 280 of the UE 120, and/or any other component(s) of FIG. 2 may perform one or more techniques associated with feedback based at least in part on energy harvesting information, as described in more detail elsewhere herein. In some aspects, the WCD described herein is the network node 110, is included in the network node 110, or includes one or more components of the network node 110 shown in FIG. 2. In some aspects, the WCD described herein is the UE 120, is included in the UE 120, or includes one or more components of the UE 120 shown in FIG. 2.For example, the controller/processor 240 of the network node 110, the controller/processor 280 of the UE 120, and/or any other component(s) of FIG. 2 may perform or direct operations of, for example, process 900 of FIG. 9 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9 and/or other processes as described herein. In some examples, executing instructions may include running the instructions, converting the instructions, compiling the instructions, and/or interpreting the instructions, among other examples.

In some aspects, the WCD includes means for transmitting an indication of EH information of the WCD; and/or means for transmitting feedback on periodic resources, including one or more of a HARQ-ACK or an indication associated with a configuration, selected from a plurality of candidate configurations, the configuration selected based at least in part on the energy harvesting information. In some aspects, the means for the WCD to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the WCD to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

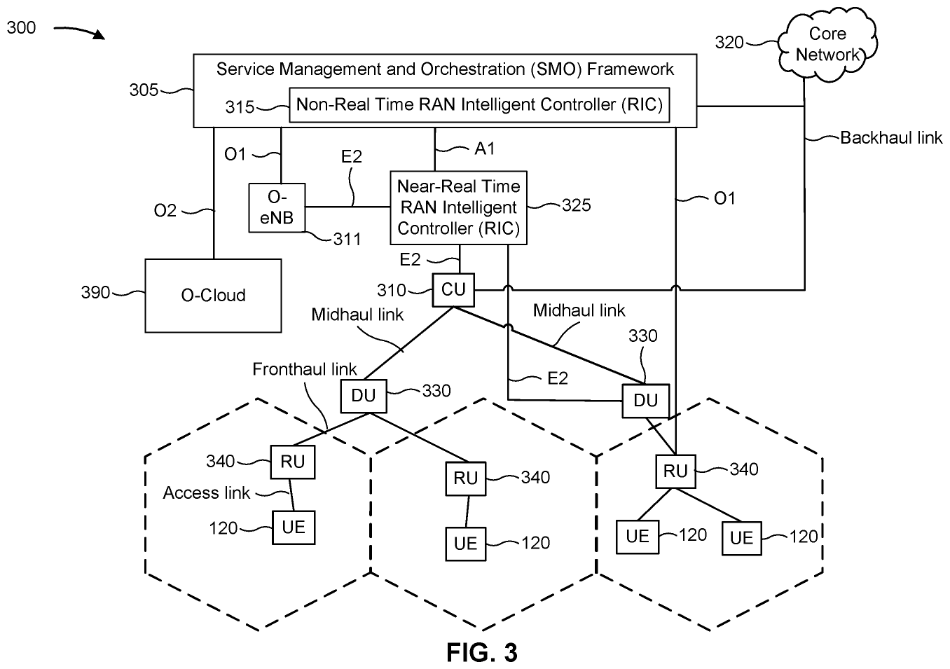

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

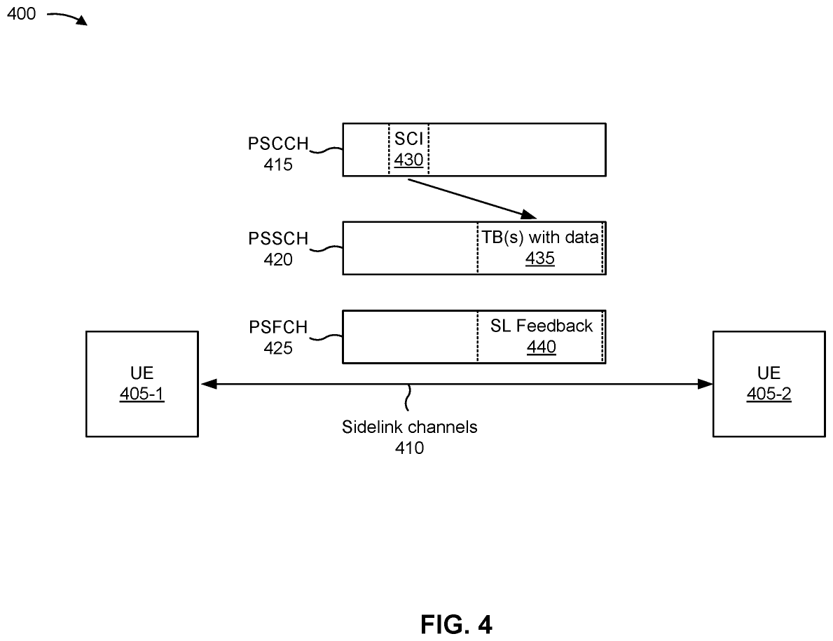

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as HARQ feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

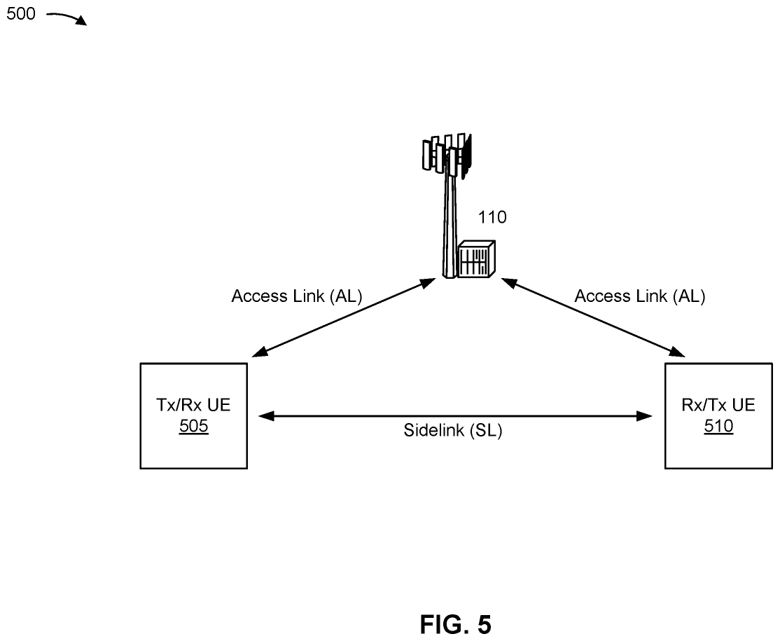

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

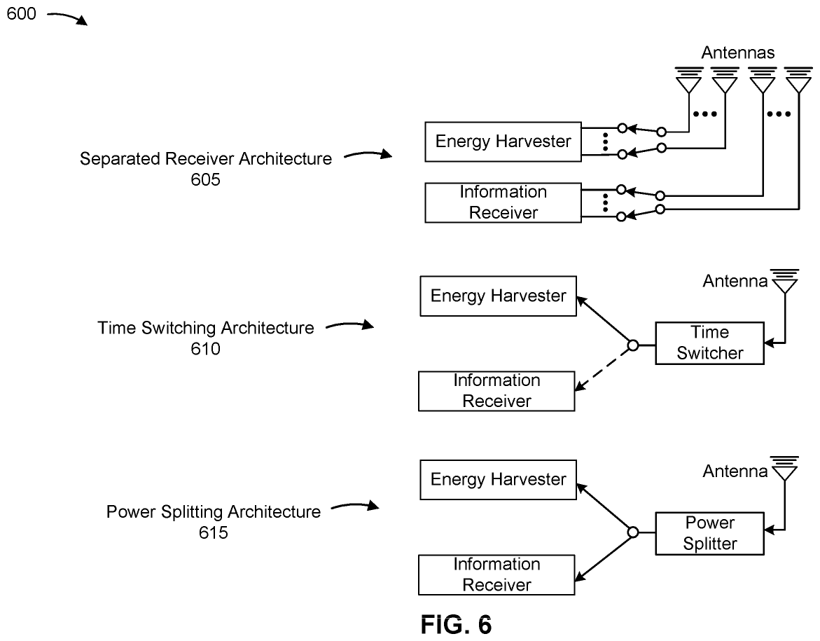

FIG. 6 is a diagram illustrating an example 600 of energy harvesting, in accordance with the present disclosure.

EH includes obtaining energy from a source other than an on-device energy storage device (e.g., a battery or a capacitor, among other examples). EH may be used to supplement energy obtained from an on-device energy storage device and/or may provide charging to the on-device energy storage device. Devices that use EH (“energy harvesting device” or “EH” device”) may have no energy storage device or a low-capacity energy storage device (e.g., zero power devices, IoT devices, passive IoT, wearables, radio frequency identification (RFID), or financial devices). EH may include converting RF/laser energy transferred from another device. The EH device may accumulate harvested energy over time (e.g., in an on-device energy storage device) to use in a subsequent operation. EH may also be a part of self-sustainable networks, where an EH device in the network may communicate within the network using energy harvested from transmissions of other devices in the network.

As shown in FIG. 6, an EH device (e.g., an RF receiver or a UE 120, among other examples) may receive signals (e.g., radio signals carried on radio waves) from a donor device (e.g., a transmitting device, an RF transmitter, a charging device, a base station 110, or a donor UE 120, among other examples) and convert electromagnetic energy of the signals (e.g., using a rectenna comprising a dipole antenna with an RF diode) into direct current electricity for use by the EH device. The EH device may be a low power device or a zero power device, among other examples.

As shown by reference number 605, in some aspects, the EH device may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed and/or decoded to receive information or other communications.

As shown by reference number 610, in some aspects, the EH device may use a time-switching architecture to harvest energy. The time switching architecture may use one or more antennas to receive signals, and whether the signals are harvested for energy or processed to receive information depends on the time at which the EH device receives the signals. For example, one or more first time slots may be time slots during which received signals are sent to one or more EH components to harvest energy, and one or more second time slots may be time slots during which received signals are processed and decoded to receive information. In some aspects, the time slots may be pre-configured (e.g., by the EH device, the donor device, or another device).

As shown by reference number 615, in some aspects, the EH device may use a power splitting architecture to harvest energy. The power splitting architecture may use one or more antennas to receive signals, and the signals are handled by one or both of the EH and/or information receiving components according to an EH rate. For example, the EH device may be configured to use a first portion of received signals for EH and the remaining received signals for information receiving. In some aspects, the EH rate may be pre-configured (e.g., by the EH device, the donor device, or another device).

The EH device may receive signals for EH on certain resources (e.g., time, frequency, and/or spatial resources) and at a certain power level that results in a particular charging rate. Energy harvested by the EH device may be used and/or stored for later use. For example, in some aspects, the EH device may be powered directly by the harvested energy. In some aspects, the EH device may use an energy storage device, such as a battery, capacitor, and/or supercapacitor, to gather and store harvested energy for immediate and/or later use.

As indicated above, FIG. 6 is provided as an example. Other examples may differ from what is described with regard to FIG. 6.

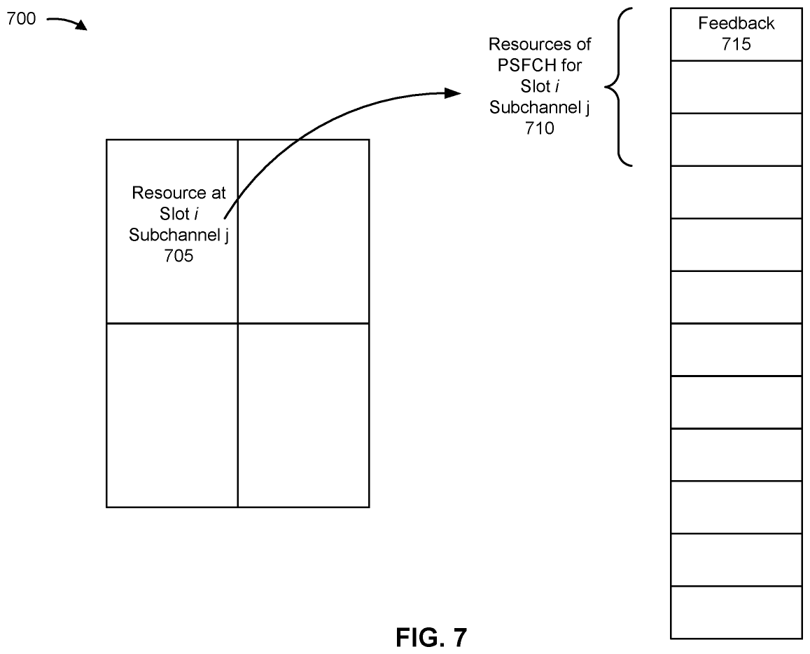

FIG. 7 is a diagram illustrating an example 700 of PSFCH resource allocations, in accordance with the present disclosure. As shown in FIG. 7, resources for sidelink communications may be divided into subchannels and slots. A subchannel may include multiple resource blocks in a frequency domain.

As shown in FIG. 7, a WCD may communicate using a resource 705 at slot i and subchannel j. The resource 705 may map to a set of resources 710 of a PSFCH for the slot i and subchannel j. In some networks, each of resource (e.g., a slot at a subchannel) may map to a set of resources of the PSFCH. In this way, a receiving device may have resources to use (e.g., free from contention) for reporting feedback on a communication received via a physical sidelink shared channel (PSSCH).

The WCD may transmit feedback 715, associated with the PSFCH and the resource 705, within a resource block of the set of resources 710. For example, the WCD may transmit the feedback in only one resource block of the set of resources 710 based at least in part on a payload of the feedback fitting within resource elements of the one resource block.

In some networks, a mapping between a PSSCH (e.g., resources at slots and subchannels of the PSSCH) and a corresponding PSFCH resource may be based at least in part on a starting sub-channel of the PSSCH (e.g., sl-PSFCH-CandidateResource Type is configured as startSubCH) or a number of subchannels in the PSSCH (sl-PSFCH-Candidate Resource Type is configured as allocSubCH). In some aspects, the mapping may be based at least in part on a slot containing the PSSCH, a source ID of a communication received in the PSSCH, a destination identification (ID), or a function (e.g., a modulo function) of parameters of the communication and/or characteristics of the UE. For example, the mapping may be based at least in part on Mod (source ID+destination ID+EH class ID and/or a configured ID). In some networks, a number of available PSFCH resources must be equal to or greater than a number of UEs in groupcast option 2.

In some networks, a PSFCH resource determination may be based at least in part on one or more configurations and/or information elements of configurations. For example, the PSFCH resource determination may be based at least in part on a an indication (e.g., periodPSFCHresource) of a periodicity of PSFCH resources (e.g., a number of slots between resources allocated for the PSFCH) that indicates the PFSCH periodicity (e.g., in a number of slots) in a resource pool. The periodicity may be set to {0,1,2,4}. If the periodicity is set to 0, PSFCH transmissions from a UE in the resource pool are disabled.

The UE may transmit the PSFCH in a first slot that includes PSFCH resources and is at least a number of slots, provided by an indication of a minimum time gap for PSFCH after receiving a communication via a PSSCH (e.g., MinTimeGapPSFCH), of the resource pool after a last slot of the PSSCH reception.

The UE may determine the resource for the PSFCH based in part on an indication of a resource block (RB) set configuration (e.g., rbSetPSFCH) that configures a set of

$${M}_{PRB , set}^{PSFCH}$$

PRBs in a resource pour for PSFCH transmission. The UE may determine the resource for the PSFCH based in part on an indication of a number of subchannels configured for PSFCH transmission (e.g., numSubchannel). For example, the indication may indicate a number of N_{subch} sub-channels for the resource pool. A value of

$${N}_{PSSCH}^{PSFCH} :$$

may be based at least in part on a number of PSSCH slots associated with a PSFCH slot, which may be determined by periodPSFCHresource. Additionally,

$${M}_{PRB , set}^{PSFCH} = α \cdot {N}_{sub ch} \cdot {N}_{PSSCH}^{PSFCH} \text{and/or} {M}_{subch , slot}^{PSFCH} = \frac{{M}_{PRB , set}^{PSFCH}}{{N}_{subch} \cdot {N}_{PSSCH}^{PSFCH}} .$$

In some networks, the UE may allocate the

$$[ ( i + j \cdot {N}_{PSSCH}^{PSFCH} ) \cdot {M}_{s ubch , slot}^{PSFCH} , ( i + 1 + j \cdot {N}_{PSSCH}^{PSFCH} ) \cdot {M}_{s ubch , slot}^{PSFCH} - 1 ]$$

RBs from

$${M}_{PRB , set}^{PSFCH}$$

where

$$0 \leq i \leq {N}_{PSSCH}^{PSFCH} and 0 \leq j \leq {N}_{subch}$$

For example,

$${N}_{PSSCH}^{PSFCH} = 4$$

for a PSFCH periodicity (e.g., the PSFCH is allocated two symbols of a last slot), N_{subch}=10 for a number of subchannels for the resource pool,

$${M}_{subch , slot}^{PSFCH} = 80 / ( 4 * 10 ) = 2$$

for 80 RBs for the PSFCH. Each sub-channel is associated with 2 PSFCH RBs in this example, but PSFCH is only sent on one of them.

In some networks, for every resource pool, based at least in part on a lack of energy or to achieve best power saving, each UE may have a different requirement for processing the PSSCH (e.g., sent on a given slot and sub-channel set) and generating the HARQ-ACK for transmitting via the PSFCH.

In some cases, the UE may need to harvest energy before being able to send the HARQ-ACK. In this way, the UE may need more than MinTimeGapPSFCH between receiving the PSSCH comm and transmitting the PSFCH feedback. Thus, based at least in part on a charging rate at the UE, a MinTimeGapPSFCH may not be suitable.

In some networks, MinTimeGapPSFCH may be dynamically changed based at least in part on a charging rate and/or may be defined based at least in part on an EH class of an associated UE. For example, each class may be characterized by a minimum or default (e.g., average) charging and/or discharging (e.g., leaking) rate.

Additionally, or alternatively, MinTimeGapPSFCH may be characterized with an energy state mode, such that when an EH UE indicates this state, a device communicating with the EH UE may be aware. Based at least in part on the indication of the state, the device may be aware that the EH UE cannot send HARQ-ACK before an associated minimum time. Additionally, or alternatively, the device may be aware that the EH UE cannot receive HARQ-ACK before an associated minimum time (e.g., based at least in part on not having sufficient power to process the HARQ-ACK).

In some aspects described herein, PSFCH periodicity and configuration may depend on an EH class of an associated WCD (e.g., UE), current charging and/or discharging rates and/or profiles, and an energy state of the WCD. Additionally, or alternatively, the energy state may be indicate in sidelink control information (SCI) so that a receiving UE can delay the HARQ-ACK as needed by the EH device (e.g., since WCD (e.g., a transmitting UE) cannot process the PSSCH (or obtain the HARQ-ACK) within MinTimeGapPSFCH. MinTimeGapPSFCH_EH_class_ES may be defined per resource pool or in a communication protocol. Additionally, or alternatively, the WCD and/or the receiving UE may dynamically report MinTimeGapPSFCH.

In some aspects, every resource pool may be configured with multiple periodicities for each EH class. In this way, a transmitting UE may determine when to receive feedback from an receiving UE and the receiving UE will determine when to send the feedback, based at least in part on knowledge of, for one or more of the UEs, a UE class, a charging profile, a discharging profile, and/or an energy state (e.g., shared during RRC_conn or as indicated in medium access control (MAC) control element (CE))

In some aspects, there may be more than one PSFCH configuration per resource pool (e.g., with different numbers of RBs and/or periodicities). Each of the PSDCH configurations may be associated with a different EH class. In some aspects, a number of RBs associated with the PSFCH may change over time. For example, a number of RBs used for PFSCH in time 1 may be different from the number of RBs in time 2. This may be based at least in part on the PSFCH being utilized by more users at some times (e.g., based at least in part on there being more classes of UEs).

In some aspects, every resource pool may be configured with multiple MinTimeGapPSFCH values based at least in part on EH class and based at least in part on energy state. For example, a smallest MinTimeGapPSFCH value may be based at least in part on an EH class, a charging profile, a discharging profile, and/or an energy state. In some aspects, an information element may indicate the smallest MinTimeGapPSFCH value that is based at least in part on the energy class (e.g., MinTimeGapPSFCH_EH_class or MinTimeGapPSFCH_EH_class_ES). In some aspects, MinTimeGapPSFCH_EH_class_ES may be defined per resource pool or within a communication protocol. Alternatively, a UE may dynamically report MinTimeGapPSFCH in SCI or via RRC or MAC layer signaling.

In some aspects, a UE may need more time to achieve a certain battery or energy state. To account for this, an energy state may be indicated in SCI so that a receiving UE may delay the HARQ-ACK since the UE cannot process the HARQ-ACK within a conventional MinTimeGapPSFCH or within the MinTimeGapPSFCH_EH_CLASS.

In some aspects, UEs may send some information about energy charging rates and whether the UEs have a charging rate that exceeds a configured charging rate configuration, configured per RP or by a network for each UE or group or class of UEs, or a set of UEs within a class. In some aspects, the UEs may provide this information within a dedicated PSFCH resource for such feedback, where each UE may indicate (e.g., using 1 bit) based at least in part on a charging rate.

In some aspects, UEs may use a same RB used for data, with a shift based at least in part on an EH class or an ID provided by the network or a transmitting UE in sidelink. In some aspects, a different CS can be used for multiplexing the feedback (e.g., an energy charging indicator bit) with a PSFCH communication used for HARQ-ACK.

In some aspects, a time gap for data HARQ-ACK may be a same or different time gap from an energy report minimum gap from a PSSCH. Hence, a charging rate may be multiplexed with a current data or different data, SCI may indicate to send the energy report, then in a PSFCH, not necessarily the one that the HARQ-ACK of a current transmission will use, can be used for charging rate report. For example, the UE may transmit an indication of MinTimeGapPSFCH_EH_class_charging_rate_report or MinTimeGapPSFCH_EH_class_ES_charging_rate_report.

Based at least in part on the WCD (e.g., EH UE that is a receiving UE) indicating EH information of the WCD, the WCD and a transmitting WCD may configure timing for feedback that allows for the WCD and/or the transmitting WCD to charge sufficiently to transmit and/or receive the feedback. In this way, the WCD and the transmitting WCD may reduce communication errors that may otherwise be caused by failing to transmit or receive the feedback, which may conserve power, computing, network, and/or communication resources that may have otherwise been consumed to detect and correct the communication errors.

FIG. 8 is a diagram of an example 800 associated with feedback based at least in part on energy harvesting information, in accordance with the present disclosure. As shown in FIG. 8, WCD (e.g., a UE or a network node 110) may communicate with a receiving WCD (e.g., UE 120). In some aspects, the WCD and the transmitting WCD may be part of a wireless network (e.g., wireless network 100) that supports sidelink communications and/or EH signals.

As shown by reference number 805, the WCD and the transmitting WCD may establish a sidelink or a Uu connection. For example, the WCD and the transmitting WCD may establish the sidelink or Uu connection directly or through another device (e.g., a network node).

As shown by reference number 810, the WCD may transmit, and the transmitting WCD may receive, an indication of EH information of the WCD. In some aspects, transmitting the indication of the EH information of the WCD includes transmitting the indication to a data transmitting WCD (e.g., the transmitting WCD). In some aspects, transmitting the indication of the EH information within one or more of sidelink or Uu link control information, RRC signaling, or medium access control layer signaling. In some aspects, transmitting the indication of the EH information includes transmitting the indication via a dedicated physical sidelink feedback channel resource, transmitting the indication multiplexed with a data channel communication, or transmitting the indication multiplexed with a feedback channel communication, among other examples. In some aspects, the feedback channel communication is associated with the sidelink feedback, additional sidelink feedback, or another type of periodic feedback.

In some aspects, the EH information of the WCD may include an energy harvesting class of the WCD, a power information report of the WCD, and/or an energy state profile of the WCD. The power information report of the WCD may include information on power and/or energy of the WCD. For example, the power information report may include power information and/or energy information. In some aspects, the power information report of the WCD includes an EH profile of the WCD indicating the power/energy harvesting from one or more of power/energy sources (e.g., solar, vibration, RF, etc) during one or more units of time and/or an energy consumption or discharging profile of the WCD indicating the power/energy consumption by the WCD during the one or more units of time.

In some aspects, the EH profile is associated with one or more energy harvesting cycle profiles indicating times and time durations of one or more energy harvesting cycles from one or more of energy harvesting sources, a prediction of a charging rate from EH from one or more energy harvesting sources supported by the WCD, a measurement of the charging rate from EH, and/or whether the charging rate satisfies a threshold, among other examples. In some aspects, the charging rate is associated with energy provided from a network node (e.g., RF, laser, or light, etc) or energy provided from a source in an environment of the WCD (e.g., solar, vibration, or another RF source). In some aspects, the EH profile may include the energy harvesting times and/or cycles and their durations performed by the WCD. In some aspects, such EH durations information can be used by the network (NW) or other UEs to avoid scheduling data transmissions or connections to WCD and/or to not expect feedback from the WCD, since WCD might be unable to perform energy harvesting and either one of signal reception or transmission during EH durations due to hardware (HW) or RF constraints. In some aspects, EH durations can be used to send energy signals to the WCD by other devices in the NW (e.g., dedicated energy sources, network nodes, other UEs, among other examples). For example, for a WCD using the time-switching RF EH architecture, the WCD may not be able to perform energy harvesting and signal reception at the same time. In some cases, a half-duplex WCD may not be able to perform both energy harvesting and signal transmission (hence, it cannot send control/data or feedback signals).

In some aspects, the energy consumption or discharging profile of the WCD is associated with a prediction of a discharging rate from the WCD (e.g., due to signals reception, filtering, storing, processing, and/or an energy storage (or battery leakage), a measurement of the discharging rate from EH, and/or whether the discharging rate satisfies a threshold (e.g., to determine if a charging or discharging source is sufficient and/or if a change to a minimum time gap is needed, among other examples).

In some aspects, the energy state profile of the WCD is associated with a prediction of energy state over one or more time, a measurement current energy state, and/or whether the energy state satisfies a threshold.

A profile (e.g., charging rate, discharging rate, energy state, among other examples) can indicate multiple values of a certain quantity (e.g., charging rate, discharging rate, energy state, energy harvesting durations, among other examples) across time for a certain time interval (e.g., within X time units wherein X is preconfigured or configured using L1, L2, and/or L3 communications and known at different NW entities and/or nodes or is provided in the report), wherein the values can be one of absolute, differential with respect to a reference value, differential with respect to one of the absolute values given in the report. For example, if an energy charging rate is [P1, P2, P3, P4] where P1 is during t1 to t2, and P2 is during t2 to t3, P3 is during t3 to t4, and P4 is during P4 to P5, wherein t1, t2, t3, t4 and X=t2−t1 are all known and configured or included in the report, the WCD reports P1, P2, P3, P4 in addition to t1, t2, t3, t4 if not previously configured or agreed. In other cases, the WCD may report P1, P2-P1, P3-P1, P4-P1, wherein the P1 (or the value of the first element) is used as a reference value. In other cases, the WCD may report P1−Px, P2−Px, P3−Px, P4−Px wherein Px is a preconfigured/configured/agreed reference value (note that this reference value is different from one quantity (charging rate, discharging rate, energy state) to another). In some cases, Px can be a value obtained from all other values, e.g., Px=F(P1, P2, P3, P4) wherein F( ) is a function in a communication protocol or an otherwise agreed. In some cases, F( ) can be an average value. In such cases of Px obtained from the remaining values, Px has to be also included in the report, hence, the WCD reports [Px, P1−Px, P2−Px, P3−Px, P4−Px]. In some cases, the quantization value or tables used for reporting the quantities are different based on whether the report is absolute or differential. In addition, the quantization resolution or tables could depend on time, e.g., quantization for P1 or P1−Px is different from P2 or P2−Px and, in some cases, the quantization resolution is higher for early reports than later ones since they might be more important and accurate (since prediction may have more errors than measurements). For example, P1 is more important than P2 since P1 may be more accurate since prediction is not as reliable as current measurements. Similarly, for t1, t2, t3, t4 if not previously agreed and will be reported, they could be reported as absolute or differential. This includes the resolution of reporting t2 relative to t1 or a reference timing (e.g., tx where in tx is L1, L2, and/or L3 configured or provided in a communication protocol or computed based at least in part on an average and is sent as part of the report or provided and/or selected by the WCD and is sent as part of report), and resolution of absolute versus differential values, or using a reference value in reporting. For EH durations/cycles, the reported quantities are the energy durations or energy cycles, for example, the WCD indicates that it will perform EH during T1 to T2, T3 to T4, etc. In case of periodic energy harvesting, the WCD can indicate a period and a certain energy harvesting active time during such period such similar to DRX, for example, periodicity is L and EH duration is Y. In some cases, the location of the EH active time may change within the EH cycle while periodicity remain the same. In some cases, the EH cycle parameters (e.g., periodicity and duration and location of EH active time) may change from time to time based at least in part on, for example, changes of environment, such as light density change in case of solar or light EH, or NW condition changes in one or more NWs through which the WCD may be harvesting RF or other wireless charging technologies. The changes of the EH cycle parameters and/or the changes of environment or NW conditions should be reported in the EH profile.

As shown by reference number 815, the WCD may receive, and the transmitting WCD may transmit, an indication of EH information of the transmitting WCD. In some aspects, the transmitting the WCD may transmit the indication of the EH information of the transmitting WCD in a manner similar to that described for the WCD.

As shown by reference number 820, the WCD may receive, and the transmitting WCD may transmit, a communication (e.g., via the sidelink or Uu connection).

As shown by reference number 825, the WCD may transmit feedback for the communication on periodic resources that are based at least in part on the EH information. For example, the WCD may transmit feedback on periodic resources, including HARQ-ACK (e.g., to a device that transmitted data) or an indication associated with a configuration that is selected based at least in part on the EH information. In some aspects, the configuration may be selected from a plurality of candidate configurations based at least in part on the EH information.

In some aspects, the plurality of candidate configurations is associated with different values of a number of resource blocks allocated for the sidelink feedback or another type of periodic feedback, a minimum time gap between reception of a data communication and transmitting the feedback, and/or a periodicity for transmitting the feedback.

In some aspects, the configuration includes a number of resource blocks allocated for the periodic feedback, a periodicity supported by the WCD for transmission of periodic feedback, and/or a minimum time gap between reception of a data communication and transmitting the periodic feedback, among other examples.

In some aspects, the periodic resources used to transmit the feedback may include PSFCH resources in a partial coverage (PC5) interface.

In some aspects (e.g., when transmitting the indication of the EH information of the WCD includes transmitting the indication to a data transmitting WCD), transmitting the periodic feedback comprises transmitting the periodic feedback to the data transmitting WCD.

In some aspects, the HARQ-ACK is associated with a received communication. In some aspects, the received communication is scheduled via a control message received via a resource pool and/or the resource pool is associated with multiple pairs of candidate configurations of the plurality of candidate configurations and values of the EH information. In some aspects, the configuration is selected from the plurality of candidate configurations based at least in part on the EH information of the WCD and the resource pool. In some aspects, the values of the EH information comprise values an EH class of the WCD, an energy state of the WCD, a dynamic charging rate of the WCD, and/or a dynamic discharging rate of the WCD, among other examples.

Based at least in part on the WCD (e.g., EH UE that is a receiving UE) indicating EH information of the WCD, the WCD and a transmitting WCD may configure timing for feedback that allows for the WCD and/or the transmitting WCD to charge sufficiently to transmit and/or receive the feedback. In this way, the WCD and the transmitting WCD may reduce communication errors that may otherwise be caused by failing to transmit or receive the feedback, which may conserve power, computing, network, and/or communication resources that may have otherwise been consumed to detect and correct the communication errors.

As indicated above, FIG. 8 is provided as an example. Other examples may differ from what is described with respect to FIG. 8.

FIG. 9 is a diagram illustrating an example process 900 performed, for example, by a WCD, in accordance with the present disclosure. Example process 900 is an example where the WCD (e.g., WCD UE 120 or network node 110) performs operations associated with feedback based at least in part on EH information.

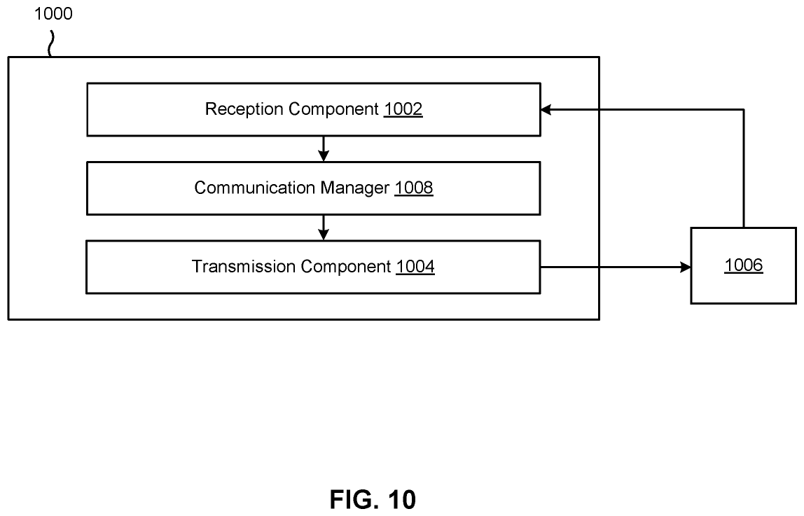

As shown in FIG. 9, in some aspects, process 900 may include transmitting an indication of EH information of the WCD (block 910). For example, the WCD (e.g., using communication manager 140 or 150 and/or transmission component 1004, depicted in FIG. 10) may transmit an indication of EH information of the WCD, as described above, for example, with reference to FIG. 8.

As further shown in FIG. 9, in some aspects, process 900 may include transmitting feedback on periodic resources, including one or more of a HARQ-ACK or an indication associated with a configuration, selected from a plurality of candidate configurations, the configuration selected based at least in part on the energy harvesting information (block 920). For example, the WCD (e.g., using communication manager 140 or 150 and/or transmission component 1004, depicted in FIG. 10) may transmit feedback on periodic resources, including one or more of a HARQ-ACK or an indication associated with a configuration, selected from a plurality of candidate configurations, the configuration selected based at least in part on the energy harvesting information, as described above, for example, with reference to FIG. 8.

Process 900 may include additional aspects, such as any single aspect or any combination of aspects described below and/or in connection with one or more other processes described elsewhere herein.

In a first aspect, the periodic resources comprise physical uplink shared channel (PUCCH) resources in radio interface, or wherein the periodic resources comprise PSFCH resources in a PC5 interface.

In a second aspect, alone or in combination with the first aspect, transmitting the indication of the energy harvesting information of the WCD comprises transmitting the indication to a data transmitting WCD, and wherein transmitting the periodic feedback comprises transmitting the periodic feedback to the data transmitting WCD.

In a third aspect, alone or in combination with one or more of the first and second aspects, the configuration includes one or more of a number of resource blocks allocated for the periodic feedback, a periodicity supported by the WCD for transmission of periodic feedback, or a minimum time gap between reception of a data communication and transmitting the periodic feedback.

In a fourth aspect, alone or in combination with one or more of the first through third aspects, the EH information of the WCD comprises one or more of an energy harvesting class of the WCD, a power information report of the WCD, or an energy state profile of the WCD.

In a fifth aspect, alone or in combination with one or more of the first through fourth aspects, the power information report of the WCD comprises one or more of an EH profile of the WCD indicating harvested energy during one or more units of time, or an energy consumption or [0001] discharging profile of the WCD indicating energy consumption during the one or more units of time.

In a sixth aspect, alone or in combination with one or more of the first through fifth aspects, the EH profile is associated with one or more energy harvesting cycle profiles indicating times and time durations of one or more energy harvesting cycles from one or more of energy harvesting sources, a prediction of a charging rate from EH from one or more energy harvesting sources supported by the WCD, a measurement of the charging rate from EH, and/or whether the charging rate satisfies a threshold.

In a seventh aspect, alone or in combination with one or more of the first through sixth aspects, the charging rate is associated with one or more of energy provided from a network node, or energy provided from a source in an environment of the WCD.

In an eighth aspect, alone or in combination with one or more of the first through seventh aspects, the energy consumption or discharging profile of the WCD is associated with one or more of a prediction of a discharging rate from the WCD, a measurement of the discharging rate from EH, whether the discharging rate satisfies a threshold.

In a ninth aspect, alone or in combination with one or more of the first through eighth aspects, the energy state profile of the WCD is associated with one or more of a prediction of energy state over one or more time, a measurement current energy state, whether the energy state satisfies a threshold

In a tenth aspect, alone or in combination with one or more of the first through ninth aspects, the HARQ-ACK is associated with a received communication, wherein the received communication is scheduled via a control message received via a resource pool, wherein the resource pool is associated with multiple pairs of candidate configurations of the plurality of candidate configurations and values of the EH information, and wherein the configuration is selected from the plurality of candidate configurations based at least in part on the EH information of the WCD and the resource pool.

In an eleventh aspect, alone or in combination with one or more of the first through tenth aspects, the values of the EH information comprise values of one or more of an EH class of the WCD, an energy state of the WCD, a dynamic charging rate of the WCD, or a dynamic discharging rate of the WCD.

In a twelfth aspect, alone or in combination with one or more of the first through eleventh aspects, transmitting the indication of the EH information comprises transmitting the indication of the EH information within one or more of sidelink or Uu link control information, RRC signaling, or medium access control layer signaling.

In a thirteenth aspect, alone or in combination with one or more of the first through twelfth aspects, the plurality of candidate configurations is associated with different values of one or more of a number of resource blocks allocated for the feedback, a minimum time gap between reception of a data communication and transmitting the feedback, or a periodicity for transmitting the feedback.

In a fourteenth aspect, alone or in combination with one or more of the first through thirteenth aspects, transmitting the indication of the EH information comprises transmitting the indication via a dedicated feedback channel resource (e.g., dedicated PSFCH resource), transmitting the indication multiplexed with a data channel communication, or transmitting the indication multiplexed with a feedback channel communication,

In a fifteenth aspect, alone or in combination with one or more of the first through fourteenth aspects, the feedback channel communication is associated with the feedback, or additional feedback.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a wireless communication device, or a wireless communication device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manger 1008 (e.g., the communication manager 140 or 150).

In some aspects, the apparatus 1000 may be configured to perform one or more operations described herein in connection with FIG. 8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the wireless communication device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the wireless communication device described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the wireless communication device described in connection with FIG. 2. In some aspects, the transmission component 1004 may be co-located with the reception component 1002 in a transceiver.

The transmission component 1004 may transmit an indication of EH information of the WCD. The transmission component 1004 may transmit feedback on periodic resources, including one or more of a HARQ-ACK or an indication associated with a configuration, selected from a plurality of candidate configurations, the configuration selected based at least in part on the energy harvesting information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a wireless communication device (WCD), comprising: transmitting an indication of energy harvesting (EH) information of the WCD; and transmitting feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.

Aspect 2: The method of Aspect 1, wherein the periodic resources comprise physical uplink shared channel (PUCCH) resources in radio interface, or wherein the periodic resources comprise physical sidelink feedback channel (PSFCH) resources in a partial coverage (PC5) interface.

Aspect 3: The method of Aspect 1, wherein transmitting the indication of the energy harvesting information of the WCD comprises transmitting the indication to a data transmitting WCD, and wherein transmitting the periodic feedback comprises transmitting the periodic feedback to the data transmitting WCD.

Aspect 4: The method of Aspect 1, wherein the configuration includes one or more of: a number of resource blocks allocated for the periodic feedback, a periodicity supported by the WCD for transmission of periodic feedback, or a minimum time gap between reception of a data communication and transmitting the periodic feedback.

Aspect 5: The method of Aspect 1, wherein the EH information of the WCD comprises one or more of: an energy harvesting class of the WCD, a power information report of the WCD, or an energy state profile of the WCD.

Aspect 6: The method of Aspect 5, wherein the power information report of the WCD comprises one or more of: an EH profile of the WCD indicating harvested energy during one or more units of time, or an energy consumption or discharging profile of the WCD indicating energy consumption during the one or more units of time.

Aspect 7: The method of Aspect 6, wherein the EH profile is associated with one or more of: associated with one or more energy harvesting cycle profiles indicating times and time durations of one or more energy harvesting cycles from one or more of energy harvesting sources, a prediction of a charging rate from EH from one or more energy harvesting sources supported by the WCD, a measurement of the charging rate from EH, and/or whether the charging rate satisfies a threshold.

Aspect 8: The method of Aspect 7, wherein the charging rate is associated with one or more of: energy provided from a network node, or energy provided from a source in an environment of the WCD.

Aspect 9: The method of Aspect 6, wherein the energy consumption or discharging profile of the WCD is associated with one or more of: a prediction of a discharging rate from the WCD, a measurement of the discharging rate from EH, whether the discharging rate satisfies a threshold.

Aspect 10: The method of Aspect 5, wherein the energy state profile of the WCD is associated with one or more of: a prediction of energy state over one or more time, a measurement current energy state, whether the energy state satisfies a threshold

Aspect 11: The method of Aspect 1, wherein the HARQ-ACK is associated with a received communication, wherein the received communication is scheduled via a control message received via a resource pool, wherein the resource pool is associated with multiple pairs of candidate configurations of the plurality of candidate configurations and values of the EH information, and wherein the configuration is selected from the plurality of candidate configurations based at least in part on the EH information of the WCD and the resource pool.

Aspect 12: The method of Aspect 11, wherein the values of the EH information comprise values of one or more of: an EH class of the WCD, an energy state of the WCD, a dynamic charging rate of the WCD, or a dynamic discharging rate of the WCD.

Aspect 13: The method of Aspect 1, wherein transmitting the indication of the EH information comprises: transmitting the indication of the EH information within one or more of sidelink or Uu link control information, radio resource control (RRC) signaling, or medium access control layer signaling.

Aspect 14: The method of Aspect 1, wherein the plurality of candidate configurations are associated with different values of one or more of: a number of resource blocks allocated for the feedback, a minimum time gap between reception of a data communication and transmitting the feedback, or a periodicity for transmitting the feedback.

Aspect 15: The method of Aspect 1, wherein transmitting the indication of the EH information comprises: transmitting the indication via a dedicated feedback channel resource, transmitting the indication multiplexed with a data channel communication, or transmitting the indication multiplexed with a feedback channel communication,

Aspect 16: The method of Aspect 15, wherein the feedback channel communication is associated with: the feedback, or additional feedback.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, references to “power” or to “energy” may be interchangeable. For example, a reference to a “power information report” may also, or in the alternative, refer to an “energy information report.” In some aspects, energy information may be derived from power information and/or power information may be derived from energy information. Therefore, a feature that refers to “power” or to “energy” should be understood to also, or alternatively, refer to the other.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A wireless communication device (WCD) for wireless communication, comprising:
a memory; and
one or more processors, coupled to the memory, configured to:
transmit an indication of energy harvesting (EH) information of the WCD; and
transmit feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.

2. The WCD of claim 1, wherein the periodic resources comprise physical uplink shared channel (PUCCH) resources in radio interface, or
wherein the periodic resources comprise physical sidelink feedback channel (PSFCH) resources in a partial coverage (PC5) interface.

3. The WCD of claim 1, wherein the one or more processors, to transmit the indication of the energy harvesting information of the WCD, are configured to transmit the indication to a data transmitting WCD, and
wherein the one or more processors, to transmit the periodic feedback, are configured to transmit the periodic feedback to the data transmitting WCD.

4. The WCD of claim 1, wherein the configuration includes one or more of:
a number of resource blocks allocated for the periodic feedback,
a periodicity supported by the WCD for transmission of periodic feedback, or
a minimum time gap between reception of a data communication and transmitting the periodic feedback.

5. The WCD of claim 1, wherein the EH information of the WCD comprises one or more of:
an energy harvesting class of the WCD,
a power information report of the WCD, or
an energy state profile of the WCD.

6. The WCD of claim 5, wherein the power information report of the WCD comprises one or more of:
an EH profile of the WCD indicating harvested energy during one or more units of time, or
an energy consumption or discharging profile of the WCD indicating energy consumption during the one or more units of time.

7. The WCD of claim 6, wherein the EH profile is associated with one or more of:
one or more energy harvesting cycle profiles indicating times and time durations of one or more energy harvesting cycles from one or more of energy harvesting sources,
a prediction of a charging rate from EH from one or more energy harvesting sources supported by the WCD,
a measurement of the charging rate from EH, or
whether the charging rate satisfies a threshold.

8. The WCD of claim 7, wherein the charging rate is associated with one or more of:
energy provided from a network node, or
energy provided from a source in an environment of the WCD.

9. The WCD of claim 6, wherein the energy consumption or discharging profile of the WCD is associated with one or more of:
a prediction of a discharging rate from the WCD,
a measurement of the discharging rate from the WCD,
whether the discharging rate satisfies a threshold.

10. The WCD of claim 5, wherein the energy state profile of the WCD is associated with one or more of:
a prediction of energy state over one or more time,
a measurement current energy state, and/or
whether the energy state satisfies a threshold.

11. The WCD of claim 1, wherein the HARQ-ACK is associated with a received communication,
wherein the received communication is scheduled via a control message received via a resource pool,
wherein the resource pool is associated with multiple pairs of candidate configurations of the plurality of candidate configurations and values of the EH information, and
wherein the configuration is selected from the plurality of candidate configurations based at least in part on the EH information of the WCD and the resource pool.

12. The WCD of claim 11, wherein the values of the EH information comprise values of one or more of:
an EH class of the WCD,
an energy state of the WCD,
a dynamic charging rate of the WCD, or
a dynamic discharging rate of the WCD.

13. The WCD of claim 1, wherein the one or more processors, to transmit the indication of the EH information, are configured to:
transmit the indication of the EH information within one or more of sidelink or Uu link control information, radio resource control (RRC) signaling, or medium access control layer signaling.

14. The WCD of claim 1, wherein the plurality of candidate configurations are associated with different values of one or more of:
a number of resource blocks allocated for the feedback,
a minimum time gap between reception of a data communication and transmitting the feedback, or
a periodicity for transmitting the feedback.

15. The WCD of claim 1, wherein the one or more processors, to transmit the indication of the EH information, are configured to:
transmit the indication via a dedicated feedback channel resource,
transmit the indication multiplexed with a data channel communication, or
transmit the indication multiplexed with a feedback channel communication.

16. The WCD of claim 15, wherein the feedback channel communication is associated with:
the feedback, or
additional feedback.

17. A method of wireless communication performed by a wireless communication device (WCD), comprising:
transmitting an indication of energy harvesting (EH) information of the WCD; and
transmitting feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.

18. The method of claim 17, wherein the periodic resources comprise physical uplink shared channel (PUCCH) resources in radio interface, or
wherein the periodic resources comprise physical sidelink feedback channel (PSFCH) resources in a partial coverage (PC5) interface.

19. The method of claim 17, wherein transmitting the indication of the energy harvesting information of the WCD comprises transmitting the indication to a data transmitting WCD, and
wherein transmitting the periodic feedback comprises transmitting the periodic feedback to the data transmitting WCD.

20. The method of claim 17, wherein the configuration includes one or more of:
a number of resource blocks allocated for the periodic feedback,
a periodicity supported by the WCD for transmission of periodic feedback, or
a minimum time gap between reception of a data communication and transmitting the periodic feedback.

21. The method of claim 17, wherein the EH information of the WCD comprises one or more of:
an energy harvesting class of the WCD,
a power information report of the WCD, or
an energy state profile of the WCD.

22. The method of claim 21, wherein the power information report of the WCD comprises one or more of:
an EH profile of the WCD indicating harvested energy during one or more units of time, or
an energy consumption or discharging profile of the WCD indicating energy consumption during the one or more units of time.

23. The method of claim 22, wherein the EH profile is associated with one or more of:
one or more energy harvesting cycle profiles indicating times and time durations of one or more energy harvesting cycles from one or more of energy harvesting sources,
a prediction of a charging rate from EH from one or more energy harvesting sources supported by the WCD,
a measurement of the charging rate from EH, or
whether the charging rate satisfies a threshold.

24. The method of claim 21, wherein the energy state profile of the WCD is associated with one or more of:
a prediction of energy state over one or more time,
a measurement current energy state, and/or
whether the energy state satisfies a threshold.

25. The method of claim 17, wherein the HARQ-ACK is associated with a received communication,
wherein the received communication is scheduled via a control message received via a resource pool,
wherein the resource pool is associated with multiple pairs of candidate configurations of the plurality of candidate configurations and values of the EH information, and
wherein the configuration is selected from the plurality of candidate configurations based at least in part on the EH information of the WCD and the resource pool.

26. The method of claim 17, wherein transmitting the indication of the EH information comprises:
transmitting the indication of the EH information within one or more of sidelink or Uu link control information, radio resource control (RRC) signaling, or medium access control layer signaling.

27. The method of claim 17, wherein the plurality of candidate configurations are associated with different values of one or more of:
a number of resource blocks allocated for the feedback,
a minimum time gap between reception of a data communication and transmitting the feedback, or
a periodicity for transmitting the feedback.

28. The method of claim 17, wherein transmitting the indication of the EH information comprises:
transmitting the indication via a dedicated feedback channel resource,
transmitting the indication multiplexed with a data channel communication, or
transmitting the indication multiplexed with a feedback channel communication.

29. A non-transitory computer-readable medium storing a set of instructions for wireless communication, the set of instructions comprising:
one or more instructions that, when executed by one or more processors of a wireless communication device (WCD), cause the WCD to:
transmit an indication of energy harvesting (EH) information of the WCD; and
transmit feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.

30. An apparatus for wireless communication, comprising:
means for transmitting an indication of energy harvesting (EH) information of the WCD; and
means for transmitting feedback on periodic resources, including one or more of a hybrid automatic repeat request (HARQ) acknowledgment (HARQ-ACK) or an indication associated with a configuration, selected from a plurality of candidate configurations, the configuration selected based at least in part on the energy harvesting information.
